(19) United States
(12) Patent Application Publication
(10) Pub. No.: US 2012/0145758 A1
(43) Pub. Date: Jun. 14, 2012

(54) SHOPPING CART SHELF

(75) Inventors: CURTIS TAYLOR, Chagrin Falls, OH (US); Mat Hanson, Chagrin Falls, OH (US)

(73) Assignee: Lift2Sell, LLC

(21) Appl. No.: 13/316,992

(22) Filed: Dec. 12, 2011

Related U.S. Application Data
(60) Provisional application No. 61/422,375, filed on Dec. 13, 2010.
(60) Provisional application No. 61/452,318, filed on Mar. 14, 2011.

(51) Int. Cl. B60R 7/00

(52) U.S. Cl. 224/411

(57) ABSTRACT

A shelf for use with a shopping cart. The shelf includes a carrier section and a connection arrangement. The carrier section is designed to be connected to a front end of the shopping cart. The carrier section includes a front wall, a back wall, a mid-section, and a cavity. The cavity is formed by the front wall, a back wall, a mid-section and is designed to receive goods placed in the carrier section. The front wall is designed to move relative to the mid-section to enable a top opening in the cavity to expand and contract. The connection arrangement is designed to secure the carrier section to the front end of the shopping cart.

The present invention claims priority on U.S. Provisional Application Ser. Nos. 61/422,375 filed Dec. 13, 2010 and 61/452,318 filed Mar. 14, 2011, both of which are incorporated herein by reference.

The present invention is directed to a shelf arrangement that can be connected to a shopping cart, and more particularly to a shelf arrangement that can be connected to the front end of a standard shopping cart.

### BACKGROUND OF THE INVENTION

Various types of consumer goods are packaged in large packages to provide the consumer with a volume discount. For instance, dog food can be purchased in 10-40 lbs. packages at grocery stores, big box stores, discount stores, etc. Also, many types of commodities (e.g., flour, sugar, rice, etc.) can be purchased in bulk at various grocery stores, big box stores, discount stores, etc. These larger packages can be difficult to raise up and into a standard shopping cart or be removed from a standard shopping cart. Most shopping carts have a lower rack or shelf that is designed for bulky goods. However, it is still difficult for many to have to bend down to insert and remove the bulky items from the lower rack or shelf of the shopping cart.

In view of the current state of the art of shopping carts, there is a need for an attachment to a standard shopping cart that can be used to easily and conveniently enable a user to load and unload bulky goods onto and off of a shopping cart.

### SUMMARY OF THE INVENTION

The present invention is directed to a shelf arrangement that can be connected to a shopping cart, and more particularly to a shelf arrangement that can be connected to the front end of a standard shopping cart. The shelf of the present invention can be used to carry large bulky items (e.g., large pet food bags, large charcoal bags, large bags of staple goods [e.g., rice, flour, maize, sugar, etc.], 12 or 24 or 36 or 46 packs of beverages, ice bags, etc.) easily and conveniently on a shopping cart. The shelf of the present invention is designed to eliminate the need for a user to bend down to place/remove heavy and/or bulky items on the bottom shelf of the cart, and/or have the user lift items into/out of the shopping cart. In one non-limiting embodiment of the invention, the shelf of the present invention is connectable to the front end of the cart portion of a shopping cart. Generally, the shelf is connected at an intermediate level or height on the front end of the shopping cart on as to reduce the amount of lifting or bending required by a user to place/remove an item on the shelf. The shelf of the present invention is advantageous for individuals with bad backs and/or individuals that have difficulty lifting heavy and/or bulky items into/out of a shopping cart. As can be appreciated, shape, size, configuration, color and materials used for the shelf are non-limiting. The shelf of the present invention can be formed of many different materials. Generally durable materials such as plastic, rubber, metal, etc. are used to form one or more components of the shelf. In another and/or alternative non-limiting embodiment of the invention, the shelf of the present invention is designed to allow the shopping cart to nest within other units without modifications to the shopping carts while the shelf is secured to the front end of the shopping cart; however, this is not required. In still another and/or alternative non-limiting embodiment of the invention, the shelf of the present invention is designed to conveniently hold and carry large and/or bulky items on the front end of a shopping cart and also enable a person at checkout to easily scan a price code on the item during checkout without having to partially or fully remove the item from the shelf; however, this is not required.

In one non-limiting aspect of the present invention, the shelf includes a carrier section. The carrier section can be formed of one or more parts. In one non-limiting embodiment of the invention, 90-100% of the carrier section is formed of a single piece of a material. The material used is generally a flexible material; however, this is not required. When the material is a flexible material, the material is generally formed of a material that has a memory such that when the material is pulled or moved out of its resting state shape, the material attempts or does fully move back to its resting state shape when no force is applied to the flexible material; however, this is not required. One such non-limiting memory material is a plastic material. In another and/or alternative non-limiting embodiment of the invention, the carrier section has an arcuate profiled bottom portion; however, it can be appreciated that the profile of the bottom portion can be flat or have some other configuration. In another and/or alternative non-limiting embodiment of the invention, the side cross-sectional shape of the carrier section is generally U-shaped or V-shaped or C-shaped; however, this is not required. In yet another and/or alternative non-limiting configuration, the carrier includes a front wall and a back wall connected to the bottom portion and the thickness of the side of the bottom portion of the carrier section is thinner than at least a portion of the side of the front wall and/or a back wall so as to facilitate in the flexible bending of the bottom portion; however, this is not required. In yet another and/or alternative non-limiting embodiment of the invention, the carrier includes a front wall and a back wall connected to the bottom portion and the front and/or back walls include one or more structural features used to provide rigidity and/or strength to the front and/or back wall; however, this is not required. In still yet another and/or alternative non-limiting embodiment of the invention, the carrier includes a front wall and a back wall connected to the bottom portion and the front wall includes a curved lip that is used to facilitate in inserting items into the carrier of the shelf; however, this is not required. In another and/or alternative non-limiting embodiment of the invention, the shelf includes a mechanically pivoting structure that enables a) all or a portion of the bottom portion to pivot relative to the back wall and/or b) all or a portion of the front wall to pivot relative to all or a portion of the bottom portion; however, this is not required. The mechanically pivoting structure generally includes a hinge structure and a biasing structure (e.g., spring, flexible band or bar etc.); however, this is not required.

In another and/or alternative non-limiting aspect of the present invention, the shelf of the present invention includes a connection arrangement used to secure the carrier section to the shopping cart. The configuration, design, and manner in which the connection arrangement secures the carrier section to the cart are non-limiting. In one non-limiting embodiment of the invention, the connection arrangement can be formed of one or more parts. In another and/or alternative non-limiting embodiment of the invention, the connection arrangement can include an attachment plate designed to be positioned inside the cart of the shopping cart so as to cause a front portion of the cart to be positioned between the attachment plate and a portion of the carrier section; however, this is not required.

In still another and/or alternative non-limiting aspect of the present invention, the shelf of the present invention can optionally be designed to hold and/or display one or more graphics. The graphic can be printed material and/or electronic material (e.g., LED display, LCD display, etc.). The graphic, when used, can include informational and/or advertising information. The front face of the shelf can be optionally designed to angle upwardly so that graphic material on the front face of the shelf can be easily viewed when the shelf is in use or not in use.

In yet another and/or alternative non-limiting aspect of the present invention, the shelf of the present invention can optionally include electronic systems that can be used to generate coupons, provide information about products near the shopping cart, etc.

In still yet another and/or alternative non-limiting aspect of the present invention, the shelf of the present invention can optionally be designed to limit damage to items (e.g., cars, walls, etc.) when the front end of the cart strikes an object. The shelf can include plastic materials and/or rubber rails and/or bumpers that are designed to protect cars in parking lots and/or other objects from dings, scratches, etc. when the front of the shopping cart bumps into an object.

In another and/or alternative non-limiting aspect of the present invention, the shelf of the present invention can optionally be designed to pivot between a closed stored position and an open use position. The pivot mechanism can be spring loaded to bias the shelf in the closed position; however, this is not required. The pivot mechanism can be in the form of a flexible material (e.g., plastic, etc.) that has memory and which can be bent to one position when force is applied and then return to its original position when the force is reduced or removed. The opening and closing capabilities of the shelf are advantageous in that the shelf can be positioned to take up less space when not in use and/or facilitate in holding items in the shelf. The shelf can also be designed to not take up much space when in use.

In still another and/or alternative non-limiting aspect of the present invention, the front face of the front wall of the shelf of the present invention can optionally be designed to be configured to facilitate in bumping into the back wall of another shopping cart and facilitating in causing the back wall to rise during the cart nesting process.

In yet another and/or alternative non-limiting aspect of the present invention, the shelf of the present invention can optionally be designed to include electronic graphics so as to produce changeable pictures that may or may not be interactive with users.

In still yet another and/or alternative non-limiting aspect of the present invention, the shelf of the present invention can optionally be designed to include rubberized edges to protect the store aisles/shelves, other carts, users, nonusers, etc. from damage.

In another and/or alternative non-limiting aspect of the present invention, the shelf of the present invention can optionally be designed to include a handle to facilitate in moving the shelf between the open and closed position.

In still another and/or alternative non-limiting aspect of the present invention, the shelf is generally designed to hold packages up to about 25-200 lbs.; however, the shelf can be designed to support other weights.

It is one non-limiting object of the present invention to provide a shelf that can be connected to a shopping cart and which can be used to hold bulky items.

It is another and/or alternative non-limiting object of the present invention to provide a shelf that can be used with a shopping cart to make it easier to load and unload bulky items on the shopping cart.

It is still another and/or alternative non-limiting object of the present invention to provide a shelf that can be removably connected to a shopping cart.

It is yet another and/or alternative non-limiting object of the present invention to provide a shelf that includes a carrier section that can be connected to the front end of a shopping cart.

It is still yet another and/or alternative non-limiting object of the present invention to provide a shelf that holds and/or displays one or more graphics.

It is another and/or alternative non-limiting object of the present invention to provide a shelf that includes electronic systems that can be used to generate coupons, provide information about products near the shopping cart, etc.

It is still another and/or alternative non-limiting object of the present invention to provide a shelf that is designed to limit damage to items (e.g., cars, walls, etc.) when the front end of the cart strikes an object.

It is yet another and/or alternative non-limiting object of the present invention to provide a shelf that is designed to pivot between a closed stored position and an open use position.

It is still yet another and/or alternative non-limiting object of the present invention to provide a shelf that includes a carrier section formed of a material that is flexible and returns to its original shape after a pulling force or deforming force is removed from the carrier section.

It is another and/or alternative non-limiting object of the present invention to provide a shelf that includes a carrier section designed to be configured to facilitate in bumping into the back wall of another shopping cart and facilitating in causing the back wall to rise during the cart nesting process.

It is still another and/or alternative non-limiting object of the present invention to provide a shelf that is designed to include electronic graphics so as to produce changeable pictures that may or may not be interactive with users.

It is yet another and/or alternative non-limiting object of the present invention to provide a shelf that is designed to include rubberized edges to protect the store isles/shelves, other carts, users, nonusers, etc. from damage.

It is still yet another and/or alternative non-limiting object of the present invention to provide a shelf that is designed to include a handle to facilitate in moving the shelf between the open and closed position.

It is another and/or alternative non-limiting object of the present invention to provide a shelf that is designed to hold packaging having a weight of at least 25-200 lbs.

These and other objects and advantages will become apparent to those skilled in the art upon reading and following the description taken together with the accompanying drawings.

### BRIEF DESCRIPTION OF THE DRAWINGS

Reference may now be made to the drawings which illustrate various preferred embodiments that the invention may take in physical form and in certain parts and arrangement of parts wherein:

FIG. 1 is a front elevation view of one non-limiting configuration of the shelf in accordance with the present invention;

FIG. 2 is a back elevation view of the shelf of FIG. 1;

FIG. 3 is a side view of the shelf of FIG. 1;

FIG. 4 is a back elevation view of a front panel of the shelf of FIG. 1;

FIG. 5 is a front elevation view of the shelf of FIG. 1 that is absent the front panel of FIG. 4;

FIG. 6 is a back elevation view of a connector arrangement of the shelf of FIG. 1;

FIG. 7 is a back elevation view of a connection slat;

FIG. 8 is a is view of a connection slat of FIG. 7;

FIG. 9 is an exploded view of the shelf of FIG. 1;

FIG. 10 is a side view of the shelf of FIG. 1 connected to the cart portion of a shopping cart;

FIG. 11 is a front elevation view of the shelf of FIG. 1 illustrating the partial placement of advertising in the front of the shelf; and,

FIG. 12 is a front elevation view of the shelf of FIG. 1 illustrating the final placement of advertising on the front of the shelf.

### DETAILED DESCRIPTION OF ONE NON-LIMITING EMBODIMENT

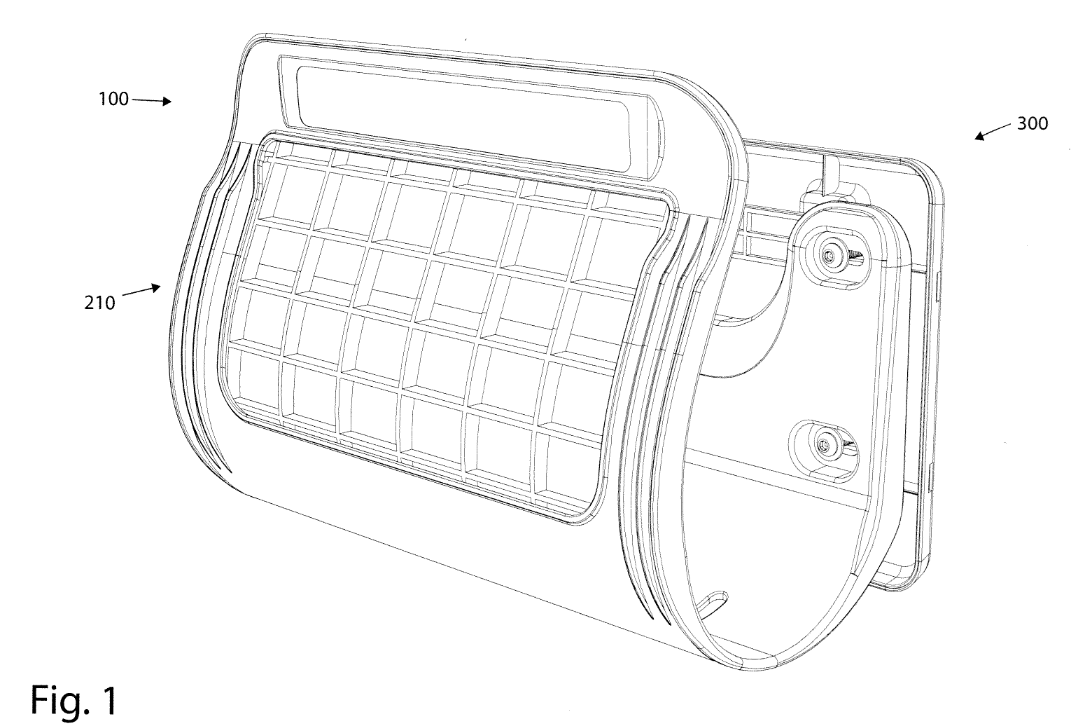

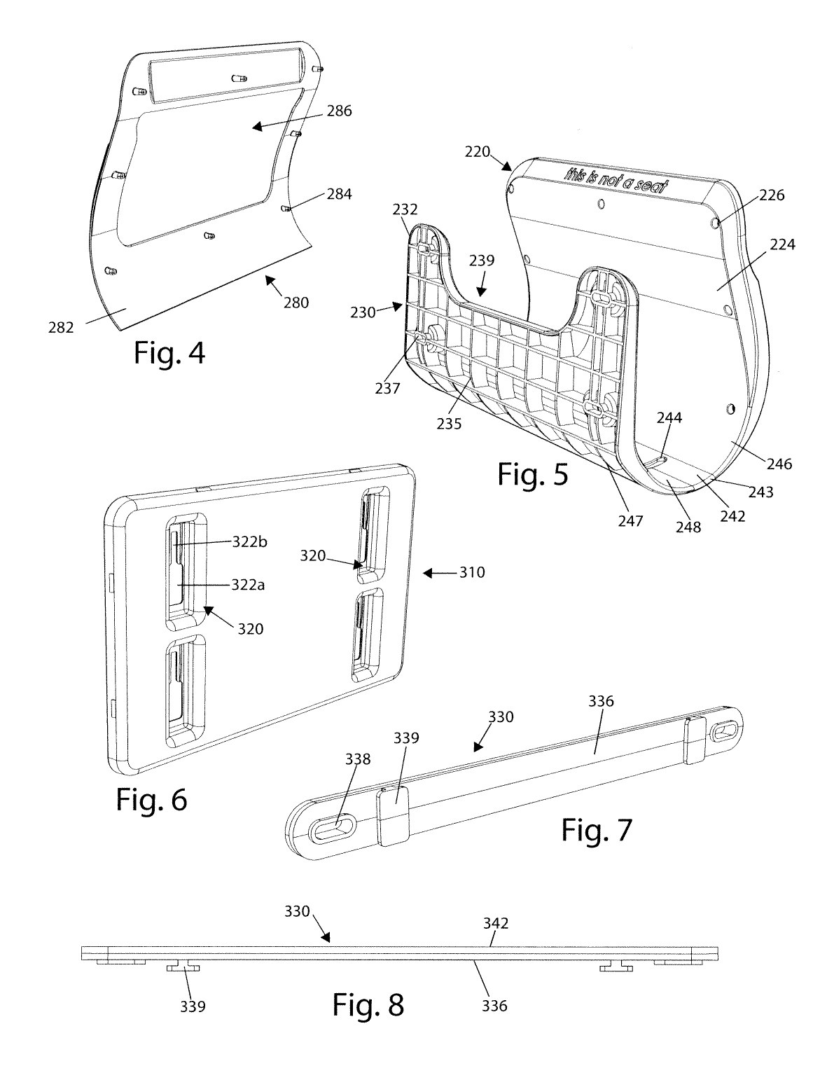

Referring now to the drawings wherein the showings are for the purpose of illustrating one non-limiting embodiment of the invention only and not for the purpose of limiting same, FIGS. 1-12 illustrate one non-limiting embodiment of the shelf for use with a shopping cart in accordance with the present invention.

Referring to FIGS. 1, 9 and 10, the shelf 100 is designed to be connected to the front end FE of the cart C of a shopping cart. The configuration and size of the cart and the shopping cart are non-limiting. As can be appreciated, the shelf can be connected on other regions of the cart (e.g., cart side, cart back end, etc.); however, this is not required. Shelf 100 is formed of a carrier section 200 and a connection arrangement 300. The connection arrangement is designed to secure the carrier section to the front end of the cart.

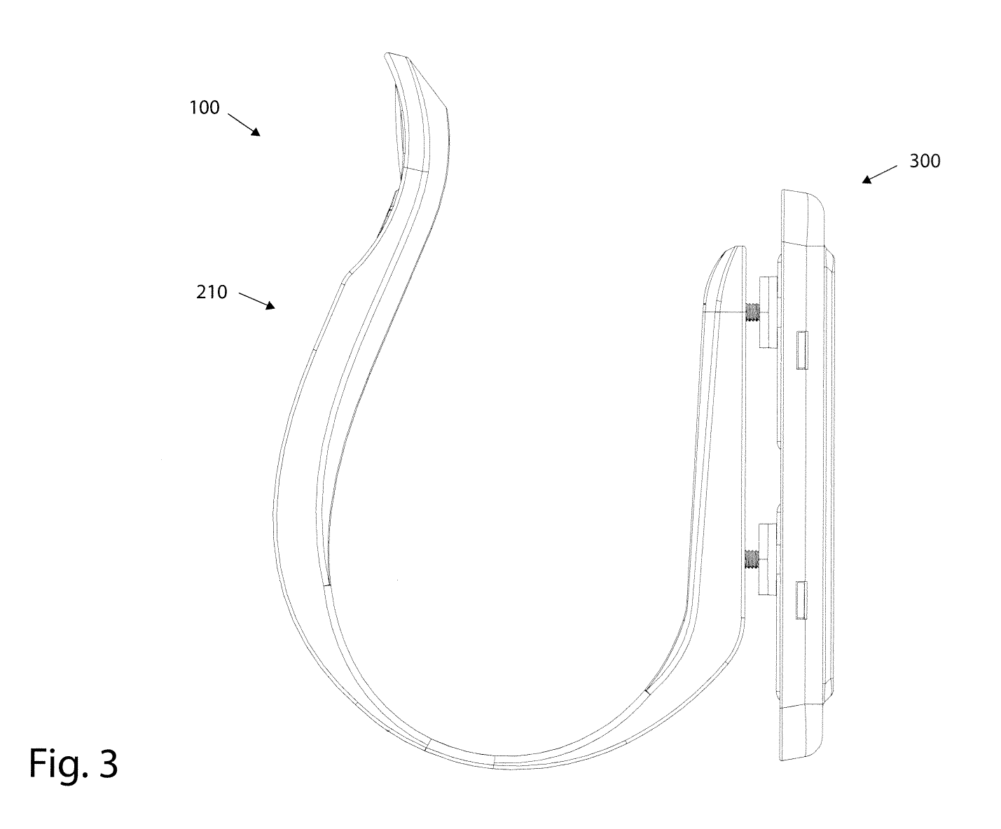

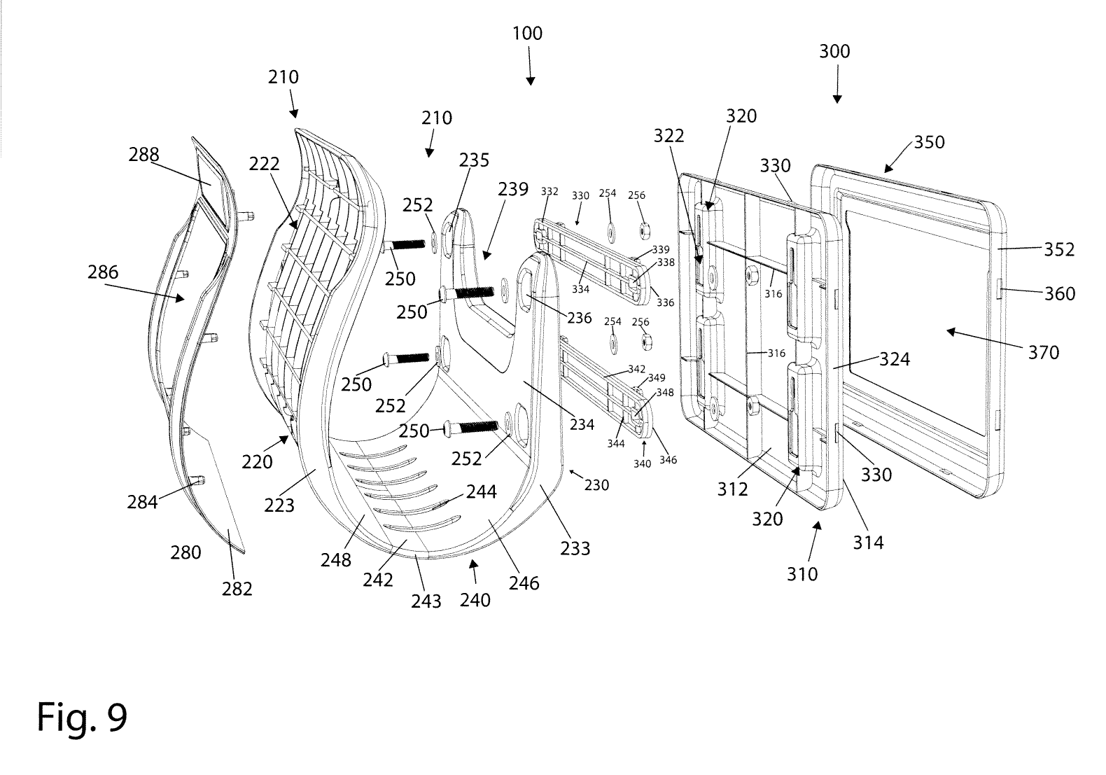

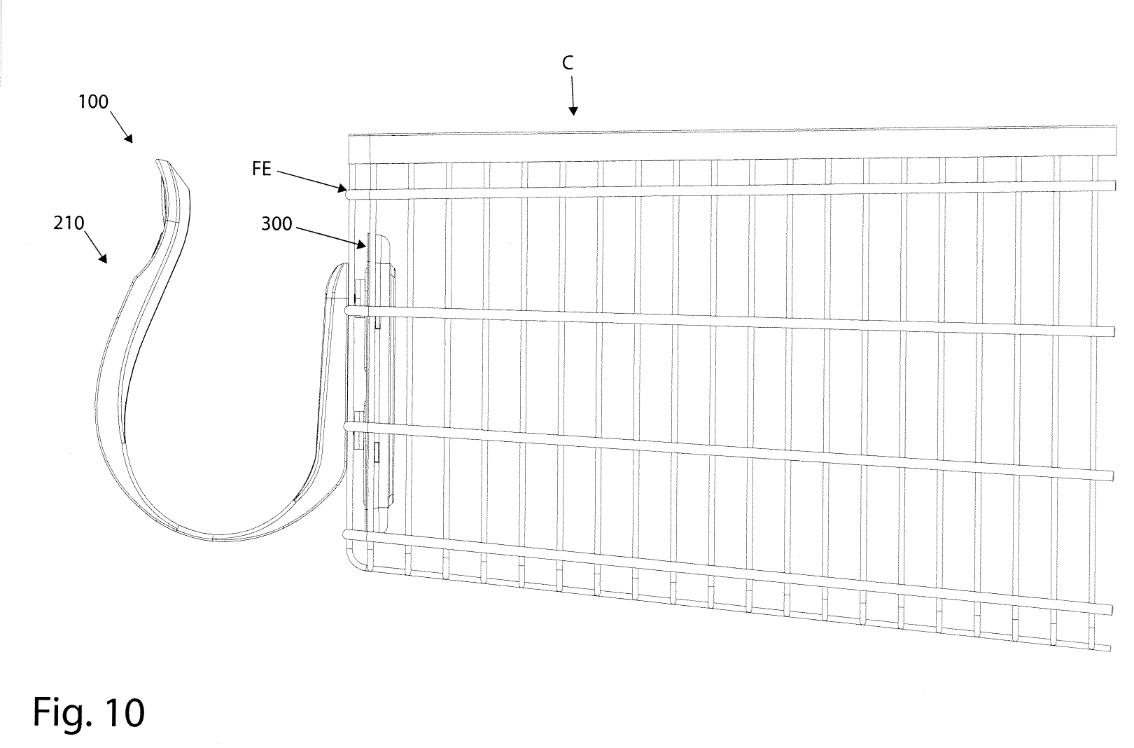

As illustrated in FIG. 10, the carrier section 200 includes a carrier section 210 and a front panel 280. The carrier section is designed to be connected to the front surface 222 of the front wall 220 of the carrier section. The carrier section includes a front wall 220, a back wall 230 and a middle or bottom portion 240. The middle or bottom in combination with the front wall and/or back wall forms a cavity that is used to hold products in the carrier section. The carrier section can be formed of one type of material; however, different potions of the carrier section can be formed of different materials (e.g., mid-section of the bottom portion is formed of a different material than used for the front wall and/or aback wall, etc.). The carrier section can be formed of one or more pieces. As illustrated in FIG. 9, the back wall and a back portion 246 of the bottom portion are formed of one piece of material, the front wall and a front portion 248 of the bottom portion are formed of one piece of material and a mid-section 242 of the bottom portion is formed of one piece of material. The mid-section can be connected to the back portion 246 and front portion 248 in any matter (e.g., melted bond, adhesive, mechanical connection, etc.). The side edge 243 of the mid-section 242 has a thickness that is generally less than a thickness of the side edges 223, 233 of the front and back walls as illustrated in FIGS. 5 and 9; however, this is not required. The thinner profile of side edge 243 is designed to enable the bottom portion to bend or flex so that the front wall can be drawn away from the back wall when items are being placed in the shelf. The material used to form all or a portion of the bottom portion is generally made of a material that has a memory to enable the material to return partially or fully back to its resting portion once the force used to cause the front wall to move away from the back wall is partially or fully eliminated. One non-limiting material is aplastic material such as, but not limited to, TPE having a durometer that enables the plastic to flex between the open and closed positions without breaking. The bottom portion has a generally U-shaped profile as illustrated in FIG. 3; however, this is not required. The bottom has a generally arcuate profile as illustrated in FIG. 3; however, this is not required.

The bottom portion of the carrier section can include one of more slots 244; however, this is not required. The one or more slots, when used, can be used to a) include the flexibility of the bottom portion, b) reduce the weight and/or materials required to form the bottom portion, and/or c) enable liquid from spills to drain from the bottom portion.

Although not shown, a pivoting arrangement can be used to connect the bottom portion 240 to the back wall 230 and/or connect the front wall 220 to the bottom portion 240. Such a pivoting arrangement generally includes a hinge arrangement and a biasing arrangement that are designed to bias the front wall toward the back wall.

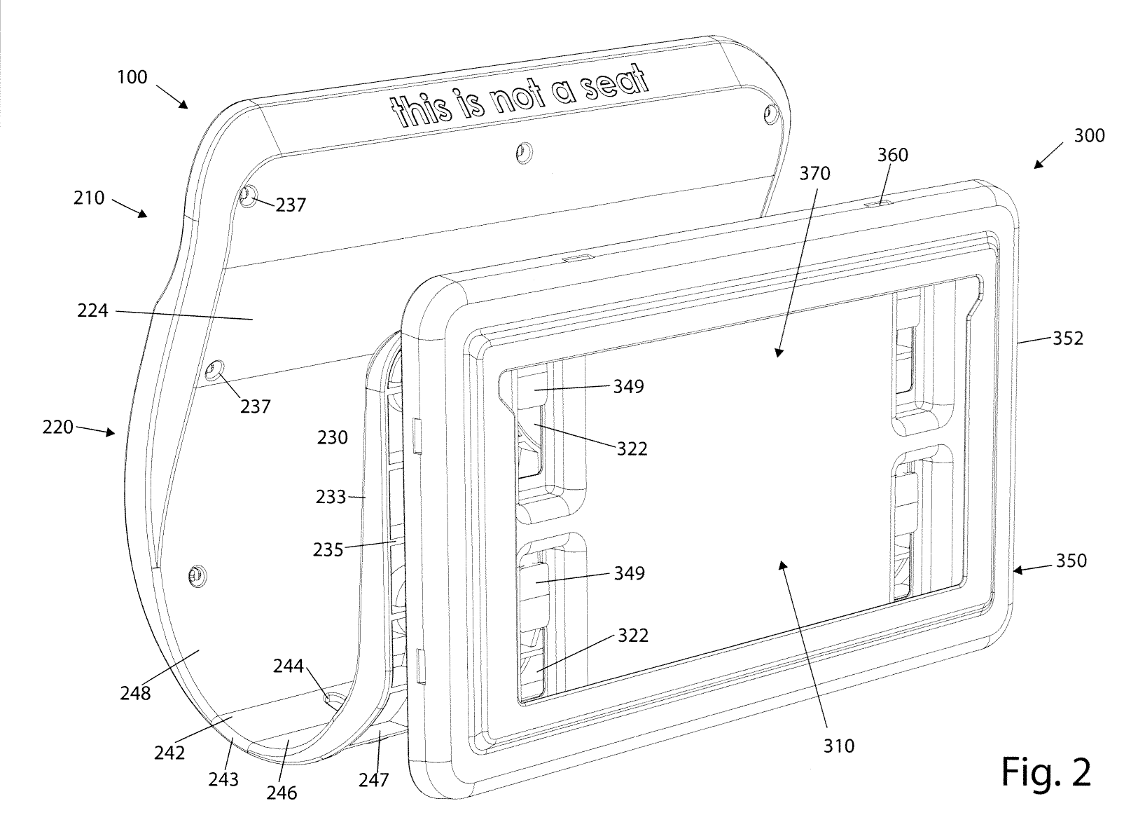

As illustrated in FIGS. 2 and 5, all or a portion of the bottom section can include reinforcement structures 247; however, this is not required. The reinforcement structures, when used, are designed to provide strength and/or rigidity to one or more portions of the bottom portion. Generally the mid-section 242 does not include reinforcement structures; however, this is not required. The shape, size and configuration of the one or more reinforcement structures are non-limiting. As illustrated in FIGS. 2 and 5, the reinforcement structures are a series of raised flanges on the bottom surface of the bottom portion. Several of the flanges intersect one or more other flanges at a nonparallel angle such as an angle of about 90; however, other intersection angles can be used. The reinforcement structures can be formed in the bottom surface of the bottom portion or otherwise connected to the bottom surface of the bottom portion by a connection means (e.g., adhesive, melted bond, mechanical connection, etc.).

The front wall 220 has a front face that includes reinforcement structures 247; however, this is not required. The reinforcement structures, when used, are designed to provide strength and/or rigidity to one or more portions of the front wall. The shape, size and configuration of the one or more reinforcement structures are non-limiting. As illustrated in FIG. 1, the reinforcement structures are a series of raised flanges on the front surface 222 of the front wall 220. Several of the flanges intersect one or more other flanges at a nonparallel angle such as an angle of about 90°; however, other intersection angles can be used. The reinforcement structures can be formed in the front surface 222 of the front wall 220 or otherwise connected to the front wall by a connection means (e.g., adhesive, melted bond, mechanical connection, etc.). The front wall is generally formed of a single piece of material; however, this is not required. The back surface 224 of the front wall is generally a smooth surface as illustrated in FIG. 3; however, this is not required.

The side profile of the front wall has a generally S-shaped profile as illustrated in FIG. 9; however, this is not required. The bottom region of the front wall curves generally toward the back wall and the upper region of the front wall curves generally away from the back wall as illustrated in FIG. 9; however, this is not required. The direction of curvature of the upper region of the front wall can be used to facilitate placing goods between the front and back walls while the shelf is connected to the cart; however, this is not required. The top edge of the front wall can include information about the shelf or a warning about the shelf as illustrated in FIG. 5; however, this is not required. The back surface of the front wall, top surface of the bottom portion and/or front surface of the back wall can include one or more designs, printed information, or the like; however, this is not required.

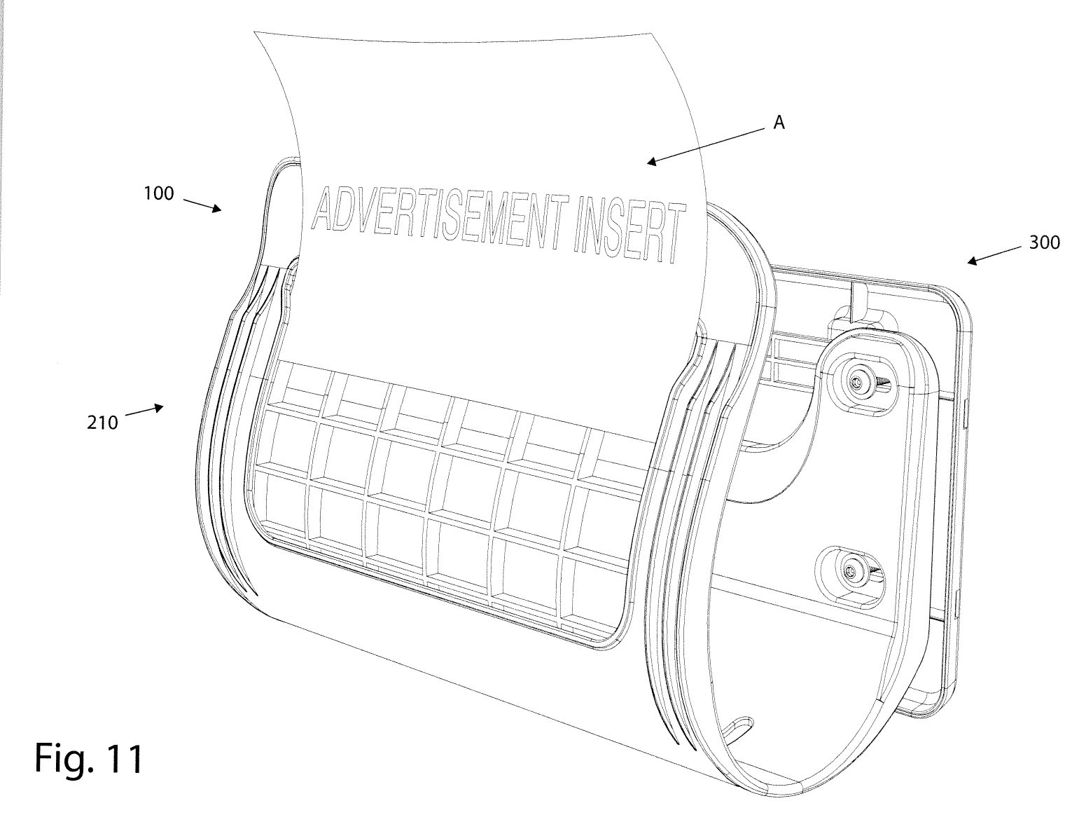

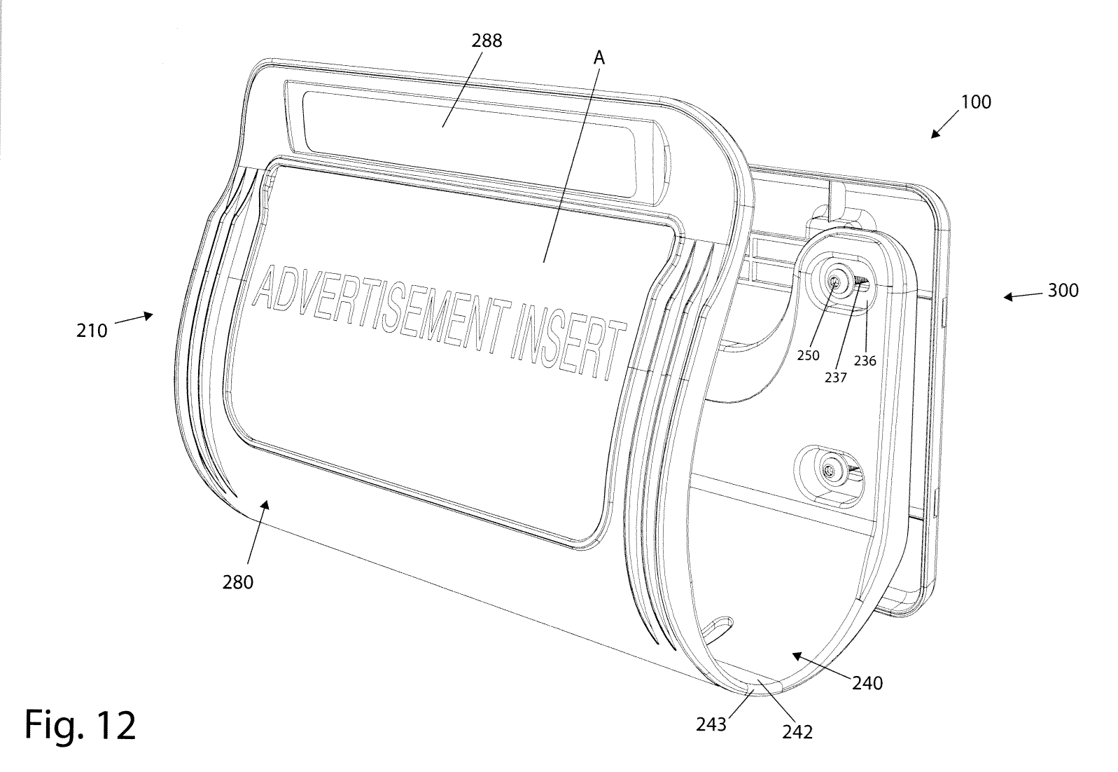

A front panel 280 is designed to be connected to the front surface of the front wall; however, this is not required. The front panel can be permanently or removably connected to the front wall. The front panel 280 includes one or more connectors 284 on the back surface of the front panel. The one or more connectors are designed to be connected in connector openings 226 in the front wall. The front panel generally has the same profile as the front surface of the front wall; however, this is not required. As illustrated in FIG. 9, the front panel has a generally S-shaped profile that matches the generally S-shaped profile of the front face of the front wall. The front panel has an opening 286; however, this is not required. As can be appreciated, opening 286 can be covered with a transparent material (e.g., clear plastic, etc.); however, this is not required. The opening in the front panel is used to forma viewing window to enable printed literature, designs; and the like to be viewed though the opening; however, this is not required. As illustrated in FIGS. 11 and 12, printed material such advertising A is positioned in the opening or the advertising can be entrapped between the front panel and the front surface of the front wall. The front panel can be designed to be removable so that different types of advertising can be easily changed out on the shelf; however, this is not required. The top portion of the front panel can optionally include a video screen 288 embedded in the front panel to display various types of information; however, this is not required. The video screen, when used, can alternatively be embedded in the front wall. As also can be appreciated, the top portion of the front panel can be left blank or include various types of printed information and/or designs.

The back wall 230 has a back face and a front face 234. The back face of the back wall includes reinforcement structures 235; however, this is not required. The reinforcement structures, when used, are designed to provide strength and/or rigidity to one or more portions of the back wall. The shape, size and configuration of the one or more reinforcement structures are non-limiting. As illustrated in FIG. 5, the reinforcement structures are a series of raised flanges on the back surface 232 of the back wall 230. Several of the flanges intersect one or more other flanges at a nonparallel angle such as an angle of about 90°; however, other intersection angles can be used. The reinforcement structures can be formed in the back surface of the back wall or otherwise connected to the back wall by a connection means (e.g., adhesive, melted bond, mechanical connection, etc.). The back wall is generally formed of a single piece of material; however, this is not required. The front surface 234 of the back wall is generally a smooth surface as illustrated in FIG. 9; however, this is not required.

The side profile of the back wall has a generally flat or planar profile as illustrated in FIG. 9; however, this is not required. This flat or planar profile is designed to facilitate in positioning the back wall up against the front end of the cart as illustrated in FIG. 10; however, this is not required.

The back wall includes a plurality of connection openings 237 that are used to secure the back wall to the connection arrangement 300. The connection openings are illustrated as recessed in the front surface of the back wall; however, this is not required. The number, shape and location of the one or more connection openings on the back wall are non-limiting. As illustrated in FIG. 12, the recess section 236 has a generally oval shape; however, this is not required and opening 237 has generally a horizontal slot configuration; however, this is not required. A connection screw or bolt 250 is designed to be inserted into the recess section and extend through the opening 237 so as to secure the back wall to the connection arrangement 300. The bolts can optionally be used with washers 252, 254 and a nut 256; however, this is not required. As can be appreciated other or additional arrangements can be used to secure the carrier section to the connection arrangement 300. The back wall has a U-shaped opening 239 as illustrated in FIG. 5; however, this is not required. The shape of opening 239, when used, is non-limiting. The opening, when included in the back wall, is generally used to 1) reduce the weight of the back wall and/or 2) reduce the materials used to form the back wall.

Referring now to FIGS. 2 and 6-9, the connection arrangement 300 is illustrated as a multi-piece unit; however, this is not required. The connection arrangement is illustrated as including an attachment plate 310, two connection slats 330, 340, and a back panel 350. As illustrated in FIG. 10, the connection arrangement 300 are all positioned in the interior of the cart C and the carrier section 210 is positioned on the exterior of the cart the bolts 250 are used to connect together the connection arrangement and the carrier section; however, this is not required. As can be appreciated, one or more components of the connection arrangement 300 can be positioned on the exterior of the cart, and/or one or more components of the carrier section can be positioned on the interior of the cart.

As illustrated in FIG. 10, the front end of the cart is clamped between the back surface of the back wall and the front surface 332, 342 of the connection slats 330, 340 when the connection arrangement and the carrier section are connected together. The connection slats are illustrated as having a similar size, shape and configuration; however, this is not required. The two connection slats can be formed of the same material; however, this is not required. The front surface of the connection slats can optionally include reinforcement structures 334, 344; however, this is not required. The reinforcement structures, when used, are designed to provide strength and/or rigidity to one or more portions of the connections slats. The shape, size and configuration of the one or more reinforcement structures are non-limiting. As illustrated in FIG. 9, the reinforcement structures are a series of raised flanges on the front surface of the connection slats. Several of the flanges intersect one or more other flanges at a nonparallel angle such as an angle of about 90°; however, other intersection angles can be used. The reinforcement structures can be formed in the front surface of the connection slats or otherwise connected to the connection slats by a connection means (e.g., adhesive, melted bond, mechanical connection, etc.). The connection slats are generally formed of a single piece of material; however, this is not required. The back surface 336, 346 of the connection slats is generally a smooth surface as illustrated in FIG. 7; however, this is not required. Each of the connection slats includes two openings 338, 348 that are designed to receive the body of bolt 250. As can be appreciated from the exploded view of FIG. 9 and FIG. 11, washers 252 are sized so as to not pass through opening 237 in the back wall. Also, washer 254 is designed to rest against the back surface 336, 346 of the connection slats and be sized to not pass through openings 338, 348 in the connection slats. Nuts 256 are tightened at the end of bolt 250 to complete the connection between the back wall of the carrier section and the connection slats.

In a simpler arrangement of the invention, it can be appreciated that attachment plate 310 and back panel 350 are not used, this are optional components of the connection arrangement. As will be described in more detail below, attachment plate 310 and back panel 350 are used to display printed information, designs, electronically displayed information, etc. so that a user pushing the cart can see such information. As discussed above, the printed information, designs, electronically displayed information, etc. that can be optionally positioned on the front wall 220 and/or front panel 280 of the carrier section is generally viewable by persons positioned in front of the cart. The information displayed on the carrier section and the connection arrangement can be the same or different.

As illustrated in FIG. 7, the back surface of the connection slats each includes one or more connection flanges 339, 349. The connection flange has a T-shaped profile; however, other profiles can be used (e.g., L-Shaped, J-shaped, etc.). As can be appreciated, more than two or less than two connection flanges can be present on one or both of the connection slats. The connection flanges are designed and configured to connect to four corresponding attachment housings 320 on the front surface 312 of attachment plate 310. Each attachment housing includes a slot opening 322 that is variable in width as illustrated in FIGS. 6 and 9. The bottom portion 322a of the slot opening has greater width to enable the connection flange on the connection slats to pass through the slot opening and into the interior of the attachment housing. The top portion 322b of the slot opening has a narrower width as illustrated in FIGS. 6 and 9 to cause the end portion of the connection flange located in the attachment housing to not pass through the narrower slot opening, thus securing the connection flange in the attachment housing as illustrated in FIG. 2. As can be appreciated, many other arrangements can be used to secure the attachment plate to the connection slats. The attachment plate is connected to the connection slats by first aligning the bottom portion 322a of the slot opening of each attachment housing with a corresponding connection flange on the connection slats. The attachment plate is then moved toward the connection slats until the top of the connection flange passes through the bottom portion 322a of the slot opening and into the attachment housing. Thereafter, the attachment plate is moved downwardly to cause the connection flange to move up the slot opening into the top portion of the slot opening, thereby securing the attachment plate to the connection slats. The reverse steps can be used to remove the attachment plate from the connection slats. As can be appreciated, this arrangement enables the attachment plate to be connected and disconnected from the cart without having to disconnect the carrier section from the cart. Indeed, the carrier section and the connection arrangement are designed to enable printed literature, designs, electronically displayed information, etc. to be changed out, repaired, etc. on either or both the carrier section and the connection arrangement without having to remove the carrier section from the cart.

The front surface 312 of the attachment plate can optionally include reinforcement structures 316; however, this is not required. The reinforcement structures, when used, are designed to provide strength and/or rigidity to one or more portions of the attachment plate. The shape, size and configuration of the one or more reinforcement structures are non-limiting. As illustrated in FIG. 9, the reinforcement structures are a series of raised flanges on the front surface of the attachment plate. Several of the flanges intersect one or more other flanges at a nonparallel angle such as an angle of about 90°; however, other intersection angles can be used. The reinforcement structures can be formed in the front surface of the attachment plate or otherwise connected to the attachment plate by a connection means (e.g., adhesive, melted bond, mechanical connection, etc.).

Referring now to FIGS. 2 and 9, back panel 350 is designed to be removably connected to the back face 314 attachment plate. The back panel 350 includes side slots 360 in the side edges 352 of the back panel. The number, shape and size of the side slots on the back panel are non-limiting. As illustrated in FIGS. 2 and 9, two side slots can be included on each of the four sides of the back panel. The side slots are designed to engage corresponding connection tabs 330 on the side edges 324 of the attachment plate. The configuration of the connection tabs and the side slots are such so as to enable the back panel to be removably connected to the attachment plate; however, this is not required. As can be appreciated, the attachment plate could include one or more side slots and the back panel could include one or more connection tabs; however, this is not required. As can also be appreciated, other or additional connection arrangements can be used to enable the back panel to be removably or irremovably connected to the attachment plate. The back panel includes an opening 370. Opening 370 is used to enable printed literature, designs, electronically displayed information, etc., not shown, to be viewed. Generally the printed literature, design, electronically displayed information, etc. is entrapped between the back surface of the attachment plate and the back panel. As can be appreciated, the printed literature, designs, electronically displayed information, etc. can be connected to the back panel and/or attachment plate in other or additional ways. The printed literature, designs, electronically displayed information, etc. can be easily removed by simply detaching the back panel from the attachment plate.

As illustrated in FIG. 10, the carrier section has a size such that the total height of the carrier portion is less than or equal to the height of the front end of the cart. Generally, the total height of the carrier portion is less than the height of the front end of the cart. Also, the maximum width of the carrier portion is less than or equal to the width of the front end of the cart. Generally, the maximum width of the carrier portion is less than the width of the front end of the cart. This sizing of the carrier section enables the carts to be nested together during storage. As illustrated in FIG. 10, the side edge 223 of the front wall has a curved profile and has a thicker width in the mid region of the front wall. Such shape and thickness are designed to facilitate in causing the back portion of another cart, not shown, to be lifted by the carrier portion when two shopping carts are nested together. The thicker width facilitates in reducing damage to the carrier section when the carts are nested together. The front panel and/or portions of the front wall can include a bumper material (e.g., rubber, etc.) to limit damage to the carrier section; however, this is not required.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

I claim:

1. A shelf for use with a shopping cart comprising a carrier section and a connection arrangement, said carrier section designed to be connected to a front end of the shopping cart, said carrier section including a front wall, a mid-section, and a cavity, said cavity designed to receive goods placed in said carrier section, said front wall designed to move relative to said mid-section to enable a top opening in said cavity to expand and contract, said connection arrangement designed to secure said carrier section to the front end of the shopping cart.

2. The shelf as defined in claim 1, wherein said carrier section includes a back wall, said back wall connected to connection arrangement, said mid-section connected to both said front and back walls.

3. The shelf as defined in claim 1, wherein said carrier section includes a front panel that is removably connected to said front wall, said front panel including an opening to enable media to be viewed through said opening on said front panel, said media connected to said front wall, said front panel, entrapped between said front wall and said front panel, or combinations thereof, said media selected form the group consisting of printed information, printed designs and electronically displayed material.

4. The shelf as defined in claim 1, wherein said connection arrangement includes a back panel that is removably connected to an attachment plate of said connection arrangement, said back panel including an opening to enable media to be viewed through said opening on said back panel, said media connected to said attachment plate, said back panel, entrapped between said attachment plate and said back panel, or combinations thereof, said media selected form the group consisting of printed information, printed designs and electronically displayed material.

5. The shelf as defined in claim 3, wherein said connection arrangement includes a back panel that is removably connected to an attachment plate of said connection arrangement, said back panel including an opening to enable media to be viewed through said opening on said back panel, said media connected to said attachment plate, said back panel, entrapped between said attachment plate and said back panel, or combinations thereof, said media selected form the group consisting of printed information, printed designs and electronically displayed material.

6. The shelf as defined in claim 1, wherein said mid-section is formed of a flexible material to enable said front wall to move relative to the mid-section to enable said expansion and contraction of said top opening in said cavity.

7. The shelf as defined in claim 6, wherein said mid-section includes a side edge having a thickness, a side edge of said front wall has a thickness that is greater than a thickness of said side edge of said mid-section.

8. The shelf as defined in claim 7, wherein said side edge of said front wall that is positioned adjacent said mid-section has a thickness that is greater than a thickness of said side edge of said mid-section.

9. The shelf as defined in claim 1, wherein said mid-section has an arcuate shape, a side profile of said carrier section is U-shaped.

10. The shelf as defined in claim 4, wherein said attachment plate and said back panel are removably connected to the cart while said carrier section remains connected to the cart.

11. A shopping cart that includes a shelf connected to a front end of a cart portion of said shopping cart, said shelf including a carrier section and a connection arrangement, said carrier section designed to be connected to said front end of the shopping cart, said carrier section including a front wall, a mid-section and a cavity, said cavity designed to receive goods placed in said carrier section so that the goods can be supported forward of the front end of said cart portion, said front wall designed to move relative to said mid-section to enable a top opening in said cavity to expand and contract, said connection arrangement designed to secure said carrier section to the front end of the shopping cart.

12. The shopping cart as defined in claim 11, wherein said carrier section includes a back wall, said back wall connected to connection arrangement, said mid-section connected to both said front and back walls.

13. The shopping cart as defined in claim 11, wherein said carrier section includes a front panel that is removably connected to said front wall, said front panel including an opening to enable media to be viewed through said opening on said front panel, said media connected to said front wall, said front panel, entrapped between said front wall and said front panel, or combinations thereof, said media selected from the group consisting of printed information, printed designs and electronically displayed material.

14. The shopping cart as defined in claim 11, wherein said connection arrangement includes a back panel that is removably connected to an attachment plate of said connection arrangement, said back panel including an opening to enable media to be viewed through said opening on said back panel, said media connected to said attachment plate, said back panel, entrapped between said attachment plate and said back panel, or combinations thereof, said media selected from the group consisting of printed information, printed designs and electronically displayed material.

15. The shelf as defined in claim 13, wherein said connection arrangement includes a back panel that is removably connected to an attachment plate of said connection arrangement, said back panel including an opening to enable media to be viewed through said opening on said back panel, said media connected to said attachment plate, said back panel, entrapped between said attachment plate and said back panel, or combinations thereof, said media selected form the group consisting of printed information, printed designs and electronically displayed material.

16. The shopping cart as defined in claim 11, wherein said mid-section is formed of a flexible material to enable said front wall to move relative to the mid-section to enable said expansion and contraction of said top opening in said cavity.

17. The shelf as defined in claim 16, wherein said mid-section includes a side edge having a thickness, a side edge of said front wall has a thickness that is greater than a thickness of said side edge of said mid-section.

18. The shelf as defined in claim 17, wherein said side edge of said front wall that is positioned adjacent said mid-section has a thickness that is greater than a thickness of said side edge of said mid-section.

19. The shelf as defined in claim 11, wherein said mid-section has an arcuate shape, a side profile of said carrier section is U-shaped.

20. The shelf as defined in claim 4, wherein said attachment plate and said back panel are removably connected to the cart while said carrier section remains connected to the cart, said attachment plate and said back panel position in an interior of said cart portion, at least a portion of said front end of said cart portion entrapped between at least a portion of said carrier section and at least a portion of said connection arrangement.
